(19) United States
(12) Patent Application Publication
(10) Pub. No.: US 2024/0125681 A1
(43) Pub. Date: Apr. 18, 2024

(54) DEVICES AND METHODS FOR MIXING AND RECONSTITUTING SOLUTIONS

(71) Applicant: Payman Zamirpour, Houston, TX (US)

(72) Inventor: Payman Zamirpour, Houston, TX (US)

(21) Appl. No.: 18/047,066

(22) Filed: Oct. 17, 2022

(51) Int. Cl. G01N 1/38; G01N 35/10

(52) U.S. Cl. CPC G01N 1/38; G01N 35/1079; G01N 2035/00465

(57) ABSTRACT

Apparatuses and methods to mix and reconstitute materials into a suspension may include a base containing a motor and a head unit for holding one or more sample containers to be mixed. The motor may include a shaft connected to the head unit for effecting displacement of the sample containers in multiple directions for mixing the materials to be reconstituted. The sample containers may contain a solid to be mixed, such as in powder form, and a diluent liquid to be mixed. The sample containers may have releasably attached and received therein, and the head unit can restrain radial motion of the sample containers such that the sample containers are maintained in an upright orientation. The frequency of the motor and the magnitude of the displacement effected by the motor may be adjusted. At least two of the multiple directions of the displacement can be substantially perpendicular.

### TECHNICAL FIELD

The present disclosure relates to assemblies, apparatuses, systems, and methods for mixing materials and, more particularly, to assemblies and methods for mixing and reconstituting solutions.

### BACKGROUND

Certain compounds may be stored in solid, powder form because they are unstable or rapidly lose potency when mixed into a solution. The solid form may provide a longer shelf life at room temperature for compounds such as, for example, some pharmaceutical drugs. Before administering to a patient, however, these example drugs must be reconstituted into a suspension. The suspension can then be used, for example, in intramuscular (IM) injection or intravenous (IV) injection or infusion. Reconstitution may often involve mixing a powder consisting of solid, loose, and dry particles of various sizes and a diluent (e.g., water and/or saline) into a suspension. The powder may come in an injectable vial, to which the proper amount of diluent must be added and the vial is agitated.

If the powder and diluent are not mixed effectively or completely into the suspension, however, complications such as precipitation, ionic reaction, and denaturation of biological molecules may occur. Some injectable drugs also cannot be mixed safely or effectively in a syringe or infusion bag, or in a sanitary way in clinical vessels such flasks or multiwell plates. As a result, traditional mixing may often be carried out, for example, by manual shaking using medication bottles or vials. These procedures, however, may be inefficient, unduly time consuming, unsanitary, and/or labor intensive. The time of preparation to ready multiple samples may also add cost and complexity to the process.

Accordingly, Applicant has recognized a desire to provide improved assemblies and methods for mixing and reconstituting solutions that may be automated and more practicable, safer and more efficient, less time consuming, and/or less labor-intensive. The present disclosure may address one or more of the above-referenced drawbacks, as well as other possible drawbacks.

### SUMMARY

As referenced above, it may be desirable to provide enhanced assemblies, apparatuses, systems, and methods for mixing and reconstituting solutions. In some examples, the solution may involve a pharmaceutical drug in powder form which must be mixed shortly before injection in a patient because the drug is unstable or rapidly loses potency in a solution. In other examples, the solution to be reconstituted may be in a kitchen, biological, agricultural, and/or other environment. In some embodiments, the assemblies and methods may involve automated mixing devices capable of safe and efficient reconstitution without the risk of contamination or exposure to the ambient environment. In some embodiments, the assemblies and methods may also involve automated mixing devices capable of simultaneous and rapid reconstitution of multiple drugs and/or doses.

In some embodiments, a mixing apparatus for reconstituting solutions may include a base including a motor and a shaft driven by the motor, a head unit connected to the base having an internal volume and an opening, and a plate in the internal volume of the head unit and connected to the shaft. The shaft may extend through the opening of the head unit. The plate may support at least one receptacle for housing at least one sample container therein. The motor may be configured to mix contents of the at least one sample container by effecting displacement of the at least one sample container in a first direction relative to the base and a second direction relative to the base different from the first direction.

In some examples, the at least one sample container may have a syringe releasably attached thereto and may be inserted from above into the at least one receptacle. The at least one sample container and syringe may be moved together by the motor relative to the base of the mixing apparatus. The at least one receptacle may be loosely arranged on the plate within the internal volume of the head unit. The head unit may constrain the radial motion of the at least one receptacle so the at least one sample container contained therein is maintained in an upright orientation. An axis of at least one receptacle may be concentric with an axis of the motor, or it may be offset from an axis of the motor.

In some examples, the second direction of the displacement of the at least one sample container effected by the motor may be substantially perpendicular to the first direction of the displacement. The frequency of the motor may be adjustable, and the magnitude of the displacement of the motor may also be adjustable.

In some embodiments, a mixing apparatus for reconstituting solutions may include a base, including a motor and a shaft driven by the motor, a base plate coupled to and driven by the shaft of the motor, and a head unit connected to the base plate. The head unit may have a plurality of openings for receiving one or more receptacles. The one or more sample receptacles may include a hollow interior for receiving one or more sample containers therein. The motor may be configured to mix contents of the one or more sample containers by effecting displacement of the one or more sample containers in a first direction relative to the base and displacement in a second direction relative to the base different than the first direction. The head unit may constrain the radial motion of the one or more sample containers so the one or more sample containers are maintained in an upright orientation.

In some examples, at least one of the one or more sample container comprises a syringe releasably attached thereto such that the sample container and syringe are moved together by the head unit relative to the base of the mixing apparatus. An axis of at least one of the one or more receptacles may be offset from an axis of the motor. The one or more sample containers may fit loosely within the hollow interior of the one or more receptacles.

In some examples, the second direction of the displacement of the one or more one sample container effected by the motor may be substantially perpendicular to the first direction of the displacement. The frequency of the motor may be adjustable, and the magnitude of the displacement effected by the motor may also be adjustable.

In some embodiments, a method for reconstituting a powder into a suspension may include inserting at least a first syringe into at least a first sample container containing a liquid to be mixed and filling at least the first syringe with at least a portion of the liquid to be mixed. The method may further include withdrawing at least the first syringe containing the portion of the liquid to be mixed from at least the first sample container and inserting at least a portion of at least the first syringe containing the portion of the liquid to be mixed into at least a second sample container. The second sample container may contain a solid to be mixed. The method may also include emptying at least a portion of the liquid to be mixed from at least the first syringe into at least the second sample container.

The method may then include inserting at least the second sample container with the portion of at least the first syringe therein into one of a plurality of receptacles in a mixing apparatus. The mixing apparatus may have a base and a motor capable of effecting motion of at least the second sample container in two or more different directions relative to the base. The method may further include mixing the liquid to be mixed and the solid to be mixed by effecting the motion of at least the second sample container. The mixing may form a uniform suspension of the liquid to be mixed and the solid to be mixed in at least the second sample container. The method may also include then removing at least the second sample container with the portion of the syringe therein from the mixing apparatus and emptying at least a portion of the uniform suspension from at least the second sample container into at least the first syringe. The method may further include removing the portion of at least the first syringe from at least the second sample container.

In some examples, the solid to be mixed may be a powdered pharmaceutical drug. The method may include shaking at least the second sample container containing the solid to be mixed prior to mixing with the liquid to be mixed to loosen the solid to me mixed. Additionally, the method may include preparing one or more additional sample containers containing a liquid to be mixed and a solid to be mixed and inserting the one or more additional sample containers into one or more of the plurality of receptacles in the mixing apparatus.

In some examples, the method may include adjusting the frequency and magnitude of the displacement effected by the motor of the mixing apparatus during the mixing. At least two of the two or more different directions of the displacement relative to the base of the mixing apparatus may be perpendicular to each other. The plurality of receptacles in the mixing apparatus may constrain the radial motion of the one or more sample containers contained in the plurality of receptacles such that the one or more sample containers are maintained in an upright orientation.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic exploded view of an example mixing apparatus including an example sample container, according to embodiments of the disclosure.

FIG. 2 is a schematic perspective view of the example mixing apparatus shown in FIG. 1, according to embodiments of the disclosure.

FIG. 3A is a schematic front view of the example mixing apparatus shown in FIG. 1, according to embodiments of the disclosure.

FIG. 3B is a schematic side view of the example mixing apparatus shown in FIG. 1, according to embodiments of the disclosure.

FIG. 4 is a schematic exploded view of another example mixing apparatus including an example sample container, according to embodiments of the disclosure.

FIG. 5 is a schematic perspective view of the example mixing apparatus shown in FIG. 4, according to embodiments of the disclosure.

FIG. 6A is a schematic front view of the example mixing apparatus shown in FIG. 4, according to embodiments of the disclosure.

FIG. 6B is a schematic side view of the example mixing apparatus shown in FIG. 4, according to embodiments of the disclosure.

FIGS. 7A-7G show a simplified schematic of an example method for reconstituting a powder into a suspension, according to embodiments of the disclosure.

FIG. 8A is a block diagram of an example method for reconstituting a powder into a suspension, according to embodiments of the disclosure.

FIG. 8B is a continuation of the block diagram shown in FIG. 8A, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

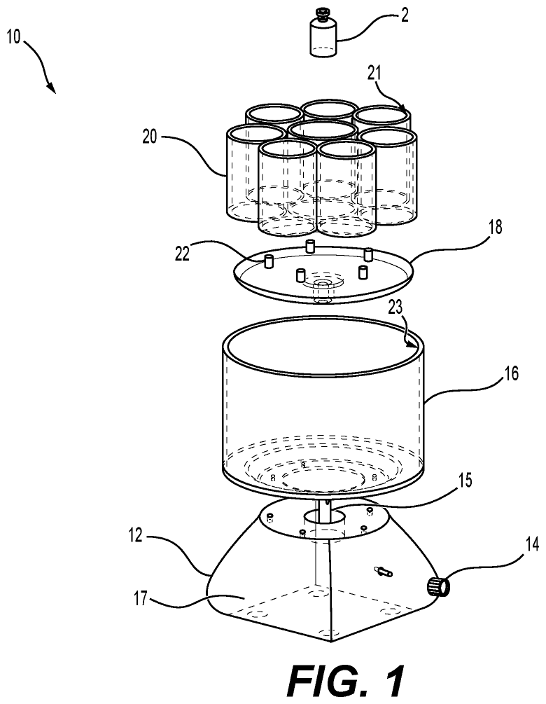

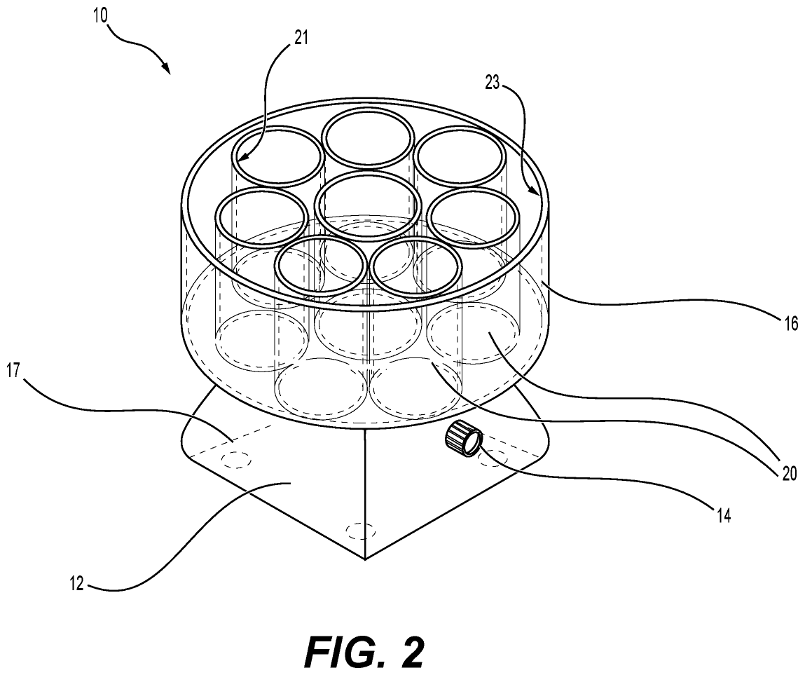

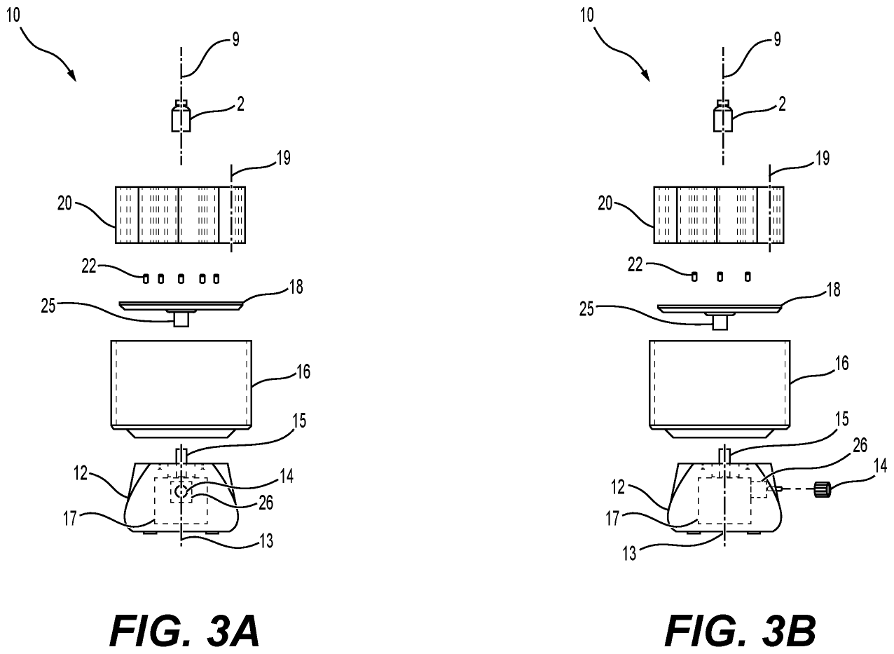

FIG. 1, FIG. 2, FIG. 3A, and FIG. 3B are a schematic views of an example mixing apparatus 10 according to embodiments of the disclosure. FIG. 1 shows an exploded view of an example mixing apparatus 10 including an example base 12, an example head unit 16, and example sample receptacles 20. The mixing apparatus may be a desk or benchtop size for ease of transport and storage. The example base 12 may be a chassis housing a motor 17 that may be configured to drive a shaft 15 to agitate and mix material in sample containers 2. The material in the sample container 2 may include, for example, a pharmaceutical drug in powder form and a liquid diluent which need to be reconstituted into a suspension prior to injection into a subject (e.g., via syringe needle, IV, etc.). The liquid diluent may be transmitted into a sample container 2 by a syringe for mixing, after which the reconstituted solution may be withdrawn back into the syringe for injection. In some examples, a drug or medication to be reconstituted may include a mixture of two or more pharmaceutical substances with a sterile diluent. The mixing apparatus 10 may provide an efficient, automated, and rapid means for reconstitution in situations where the drug may not be stable or have an extended shelf life in suspension form, and therefore must be mixed shortly before being administered.

Although some examples discussed are most often referred to in the context of reconstitution of a pharmaceutical drug with a sterile diluent in a clinical setting, this is not meant to be limiting. It will be understood by those of skill in the art that the disclosed examples and methods herein may be used in other settings such as, for example, kitchen, biological, agricultural, or any number of other applications or environments where constituents need to be mixed. These applications may include solids of a wide variety of shapes/sizes, compositions, and solubilities. Additionally, the diluents may not need to be sterile and may vary in substantial number of factors, for example pH, polarity, eluotropic strength, etc.

Effective mixing of a solid powder and a liquid diluent may depend on several factors, and the process from the initial measuring and combining of constituents to the final presentation of the suspension for delivery (which often must be kept sterile). Qualities such as ionic reaction and/or poor solubility of constituents may render manual mixing (e.g., hand shaking of a sample container) or the use or some automated mixing machines incompatible. For example, creating a vortex in a cylindrical container using a circular motion may result in, for example, solid body rotation of the powder and diluent in the container, resulting in little or no radial or vertical flow for effective mixing. Applicant has found that motion in multiple different directions may be beneficial to promoting the formation of a more uniform suspension. As a result, apparatuses and methods disclosed herein are capable of inducing motion in multiple different directions (for example, essentially perpendicular flow in both radial and vertical directions in a cylindrical vessel). The embodiments of mixing apparatuses disclosed herein are, for example, active mixers which physically move fluid during mixing, creating turbulence and breaking up the boundary layers between solid and liquid constituents.

The motor 17 may be fully contained within the base 12 of the mixing apparatus 10 can be a variety of types and may be equipped with a drive 26 (see FIG. 3A and FIG. 3B). In some embodiments, the motor 17 may be a brushless stepper motor configured to deliver discrete pulses, which can be controlled to great degree of precision, corresponding to incremental angular rotations of the shaft 15. The motor 17 may be driven so the pulses are delivered in a small number of steps, or may be driven so a large number of steps are administered in succession. In other embodiments, the motor 17 may be another electrodynamic, mechanical, hydraulic, or other suitable type known in the art. The motor 17 may be equipped with a drive 26 that is capable of receiving inputs but that does not require a feedback mechanism. In some examples, the motor 17 may have a drive 26 which is an oscillator drive for continuous motion control. In some examples, the motor 17 may be equipped with a drive 26 that is a step-direction drive which is capable of changing the direction of the discrete pulses delivered by the motor 17. In further examples, the drive 26 may be a variable frequency drive or other adjustable frequency drive.

The motor 17 may be capable of receiving an input from an input device 34 capable of adjusting the frequency and/or direction of the motor pulses directing motion of the shaft 15. The input device 34 me be, for example, an analog knob, slider, or toggle. The input device 34 may also be, for example, a digital device such as a touchscreen or button. Changing the frequency and/or direction of the motor pulses transmitted to the sample containers 2 may prevent standing waves and solid body rotation of the constituents in the sample containers 2, which may otherwise inhibit effective mixing.

The head unit 16 of the mixing apparatus 10 may be fixedly connected to the base 12 with fasteners 22 (as shown in FIG. 1, FIG. 3A, and FIG. 3B), although other suitable means such as adhesives, magnets, etc. can also be used. The head unit 16 may have a substantially cylindrical shape with a hollow internal volume 23 sized for receiving the plate 18 and one or a multitude of receptacles 20. The head unit 16 may be, for example, a thin metallic or polymeric sheet formed into a cylindrical or other shape capable of maintaining shape when agitated by the motor 17. In another example, the head unit can be constructed of open or closed cell foam or fiber reinforced composite. In some embodiments, the plate 18 may have a hub 25 with features allowing it to be driven by the shaft 15 of the motor 17, for example a spline or keyway. As the plate 18 is secured only to the shaft 15, the plate 18 and receptacles 20 are free to move (rotate, translate, oscillate, etc.) independent of the head unit 16 within the internal volume 23. The inner wall of the head unit 16 bounding the internal volume 23 can define the maximum radial travel available to the receptacles 20.

The receptacles 20 may be hollow cylinders as shown or can be some other geometry. The receptacles may be the same or different dimensions and be sized to accept, for example, commonly known sizes of sample containers 2 (e.g., drug vials or bottles). The sample containers 2 may be loaded into the mixing apparatus 10 from above through an open top of the head unit 16. The receptacles 20 may be arranged relatively loosely on the plate 18 such that they may receive the motion effected on the plate 18 and move relative to the plate 18. The receptacles 20 may be constrained radially by the inner wall of the head unit 16 and by adjacent receptacles 20 so they are maintained in a vertical or upright orientation during mixing and storage to restrain the sample containers 2 and provide stability to prevent spillage. In one example, eight receptacles 20 for receiving sample containers 2 may be arranged in a honeycomb-like pattern on the plate 18 housed within the head unit 16, as seen in FIG. 2.

It should be noted that the number of receptacles 20 in the mixing apparatus 10 is independent of the mixing function. Although only one sample container 2 is shown, for example, as in FIG. 1, it can be appreciated that the multitude of receptacles 20 held by the mixing apparatus 10 allows many sample containers 2 to be mixed simultaneously, increasing the efficiency of the reconstitution procedure. Thus, a smaller or larger number of receptacles 20 may be used, with each receptacle capable of receiving a sample container 2 therein. For example, the diameter of the head unit 16 may allow for any number of differing sized receptacles 20 to be employed to receive sample containers 2 of differing sizes and/or to constrain adjacent receptacles 20.

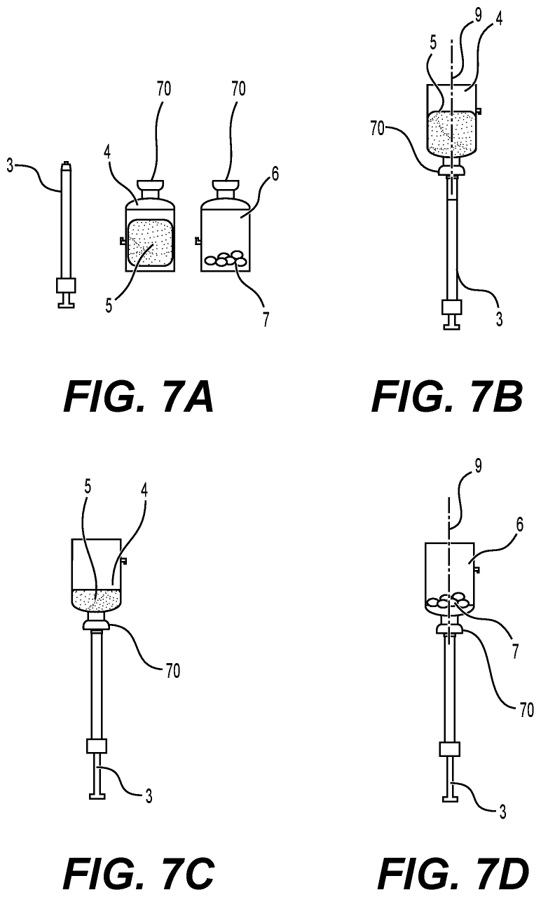

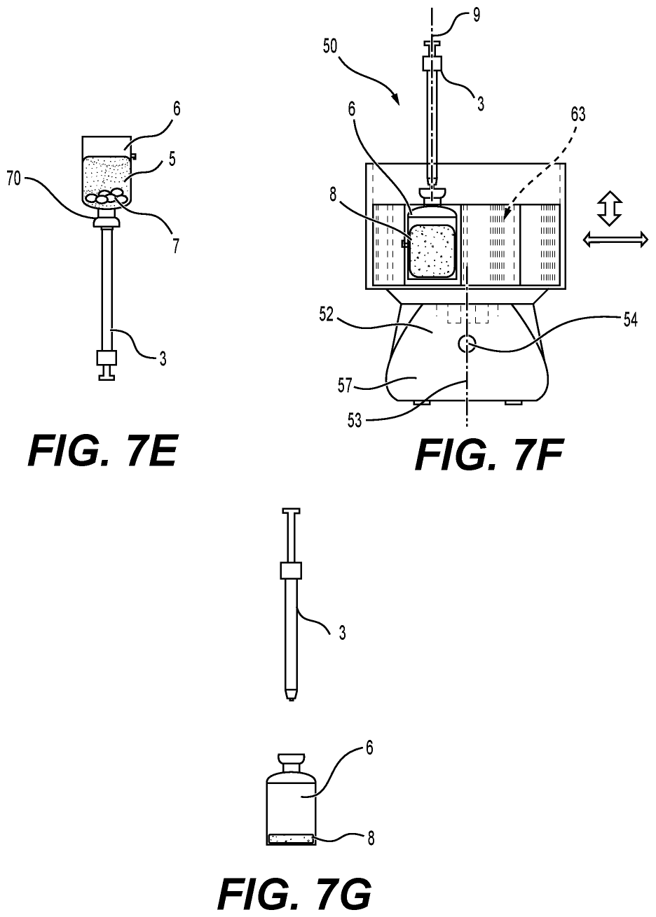

The open top organization of the receptacles 20 within the head unit 16 may allow at least the distal end of a syringe used to transfer diluent liquid to a sample container 2 to remain releasably engaged in the sample container 2 during loading, mixing, and unloading of the mixing apparatus 10 (see, e.g., syringe 3 and sample container 6 in FIG. 7F). This arrangement may be advantageous for applications where, for example, the syringe and contents are to be kept sterile during the mixing procedure to keep contamination introduced by exposure to the ambient environment to a minimum.

In some embodiments, the receptacles 20 may fit relatively loosely within the internal volume 23 of the head unit 16 such that they are kept upright but are allowed some displacement relative to the fixed base 12 and head unit 16. Similarly, the sample containers 2 may fit relatively loosely within the hollow interior 21 of the receptacles 20 such that they are kept upright but are allowed some displacement relative to the fixed base 12 and head unit 16. The receptacles 20 and sample containers 2 therein may thus be allowed to “float” on the planar surface of the plate 18 relative to the base 12 and the head unit 16. The induced displacement from the motor 17 may therefore be 3-dimensional but constrained for mixing the contents of the sample containers 2. For example, the displacement of the receptacles 20 may be rotation about a receptacle axis 19 but also translation in the radial and axial direction relative to an axis 13 of the motor 17 as seen in FIG. 3A and FIG. 3B. In the arrangement shown, at least one of the receptacles 20 may have an axis 19 concentric with an axis 13 of the motor 17, and at least one of the receptacles 20 may have an axis 19 offset from the axis 13 of the motor 17. Similarly, the displacement of the sample containers 2 may be rotation about container axis 9 but also translation in the radial and axial direction relative to receptacle axis 19 and an axis 13 of the motor 17. The induced displacement on the sample containers 2 may therefore be noncircular, and may be more reciprocating, similar to that of, for example, a vibratory shaker. As further illustrated in FIG. 3A and FIG. 3B, at least one of the sample containers 2 may also have an axis 9 concentric with an axis 13 of the motor 17, and at least one of the sample containers 2 may have an axis 9 offset from the axis 13 of the motor 17. Sample containers offset from the axis 9 of the motor 13 may, for example, experience more thorough mixing as a result of accentuated motion when the motor changes frequency and/or direction.

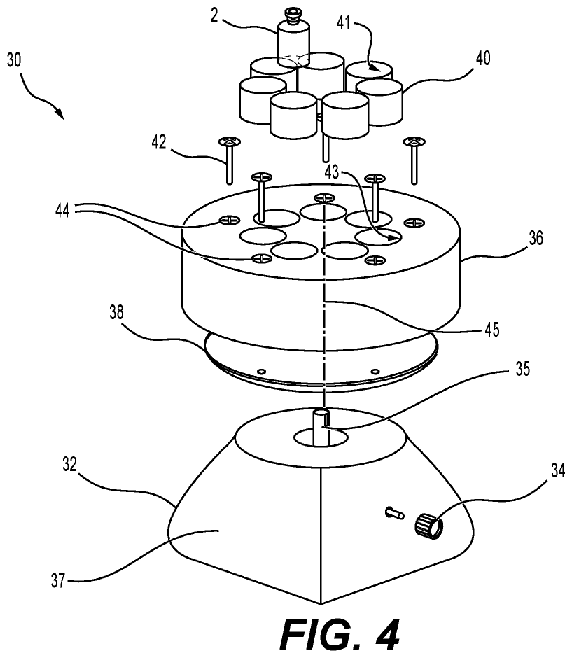

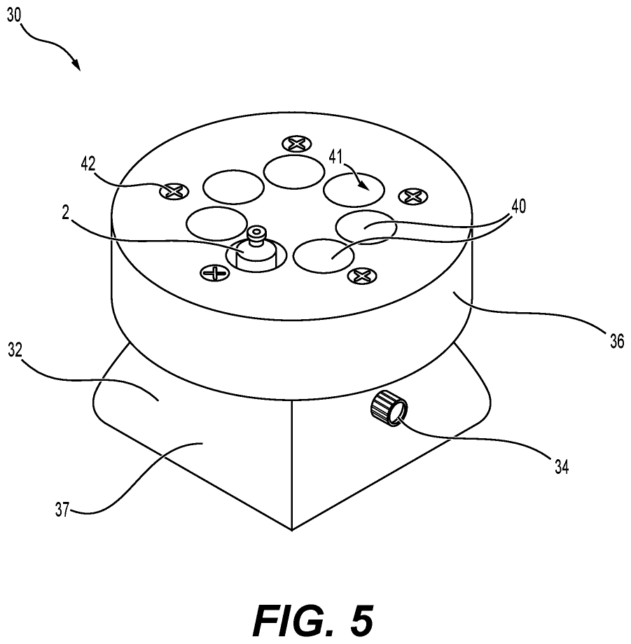

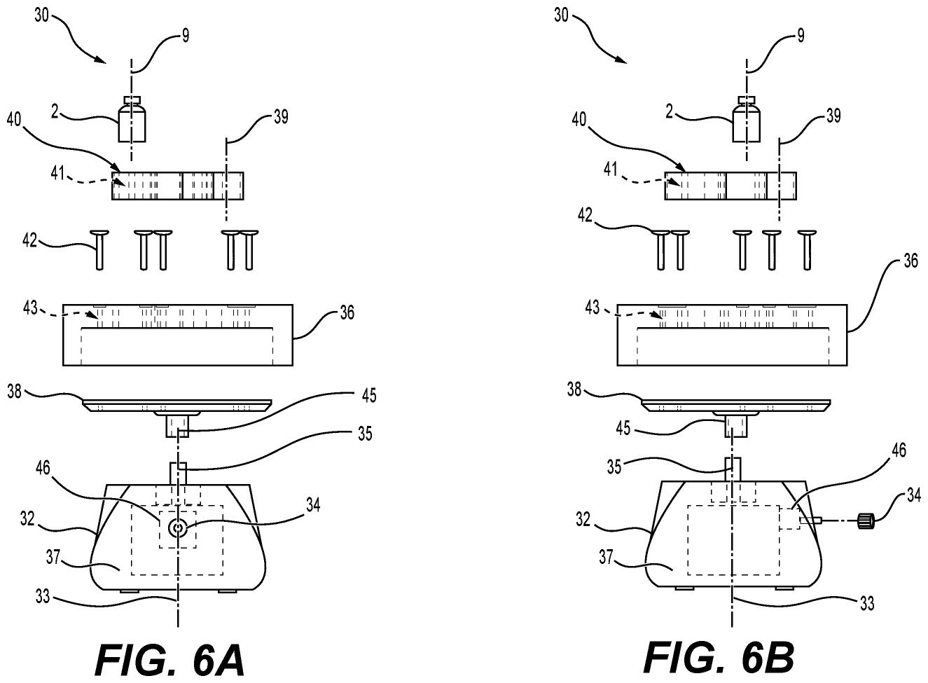

FIG. 4, FIG. 5, FIG. 6A, and FIG. 6B are a schematic views of an example mixing apparatus 30 according to embodiments of the disclosure. FIG. 5 shows an exploded view of an example mixing apparatus 30 including an example base 32, an example base plate 36, an example head unit 36, and example sample receptacles 40. The mixing apparatus may be a desk or benchtop size for ease of transport and storage. The example base 32 may have a motor 37 that may be configured to drive a shaft 35 to agitate and mix material in one or more sample containers 2. The material in the sample container 2 may include a powder form and a liquid which need to be reconstituted. The liquid diluent may be transmitted into a sample container 2 by a syringe, which can remain engaged with the sample container 2 during mixing to preserve sterility, after which the reconstituted solution may be drawn back into the syringe for injection. The one or more sample containers 2, with their associated syringes, can be loaded into the mixing apparatus 30 from the top.

Similar to other embodiments, the motor 37 of the mixing apparatus 30 may be any of a number of types. In some examples, the motor 37 may be equipped with a drive 46 and an input device 34. The input device 34 may be, for example, an analog knob, slider, or toggle. The input device 34 may also be, for example, a digital device such as a touchscreen or button. In some examples, the drive 46 may be an oscillator drive, a step-direction drive, a variable frequency drive or other adjustable frequency drive, or other suitable drive capable of changing the frequency and/or direction of the pulses generated by the motor 37 such that the displacement effected on the base plate 38 through the coupled shaft 35 is in two or more directions. In some examples, at least two of the two or more directions of displacement may be substantially perpendicular (e.g., a radial and an axial direction relative to an axis 33 of the motor 37). In some embodiments, the base plate 38 may have a hub 45 which may be coupled to the shaft 35 of the motor 37, for example, through a spline or keyway.

The head unit 36 of the mixing apparatus 30 may be substantially cylindrical and may be fixedly connected to the base plate 38 with fasteners 42 (as shown in FIG. 4, FIG. 6A, and FIG. 6B), although other suitable means such as adhesives, magnets, etc. can be appreciated. The fasteners may, for example, extend through a plurality of holes 44 and into the plate 38. FIG. 4 shows five fasteners 42 and five holes 44 in a concentric spoke-like arrangement around axis 45, though a lesser or greater number of fasteners and holes can be used so long as the head unit 36 is tightly secured to the base plate 38. Fixedly connecting the head unit 36 to the base plate 38 may couple both components as one to the shaft 35 of the motor 37.

The head unit 36 may be, for example, a metallic or polymeric volume capable of maintaining shape when agitated by the motor 17. In some embodiments, the head unit 36 may be a lightweight polymer for transmitting the most energy from the motor. In another embodiment, the head unit can be constructed of open or closed cell foam or fiber reinforced composite that is lightweight but rigid enough to constrain and hold upright any number of sample containers 2 to be reconstituted.

The head unit 36 may also have a plurality of openings 41 sized for receiving one or more receptacles 40. The openings 41 may extend as depressions partially into the head unit 36, or may extend completely through the head unit 36 as holes. In some examples, the one of the openings 41 may be concentric with the axis 45 of the head unit 36. In some examples, the openings 41 may be offset a distance from the axis 45 of the head unit 36. In some examples, the openings 41 may be offset from the axis 45 by a varying distance so the openings 41 are arranged eccentrically in a non-symmetric fashion.

In some embodiments, the receptacles 40 may be, for example, hollow sleeves sized to receive sample containers 2, such as drug vials or bottles, therein. The receptacles 40 and the openings 41 may be the same size or may be a variable number of sizes capable of receiving sample containers 2 of differing sizes to be mixed and reconstituted simultaneously. Although only one sample container 2 is shown, for example, as in FIG. 4, it can be appreciated that each of the receptacles 40 can receive a sample container 2, allowing for multiple doses and/or drugs to be mixed simultaneously.

Similar to other embodiments, the open top organization of the receptacles 40 within the head unit 36 may allow at least the distal end of a syringe used to transfer diluent liquid to a sample container 2 to remain releasably engaged in the sample container 2 during loading, mixing, and unloading of the mixing apparatus 30. This arrangement may be beneficial for applications where, for example, the syringe and contents are to be kept sterile during the mixing procedure to keep contamination introduced by exposure to the ambient environment to a minimum during the preparatory and reconstitution process.

In some embodiments, the receptacles 40 may fit relatively loosely within the openings 41 of the head unit 36. In some embodiments, there may be a snug fit between the receptacles 40 and the openings 41. The sample containers 2 may fit relatively loosely within the hollow interior of the receptacles 40 such that they are allowed some displacement relative to the fixed base 32 and are kept constrained in the upright or vertical orientation by the receptacles 40 and the openings 41 in the head unit 36. The displacement of the sample containers 2 induced by the motor 17 may be rotation about an axis 9 of the sample container 2 but also a relative translation in the radial and axial direction relative to an axis 33 of the motor 37 as seen in FIG. 6A and FIG. 6B.

FIGS. 7A-7G offer a pictorial representation of an example method for mixing and reconstituting a solution. Referring to FIG. 7A, a solution to be mixed may include a liquid to be mixed 5 in a first sample vial, bottle, or container 4 and a solid to be mixed 7 in a second sample vial, bottle, or container 6. The liquid to be mixed 5 can be, for example, water, saline of a certain concentration, or any other diluent, solvent, and/or pre-prepared mixing solution as described herein. The solid to be mixed 7 can be, for example, medicinal, kitchen, biological, agricultural, or any number of other applications or environments. In some embodiments, the solid may be a sealed powdered pharmaceutical drug, a lyophilized medicament, and/or another solid which needs to be reconstituted. In some examples, a syringe 3 or other transfer device may be used for transferring and/or administering the constituents of the sample containers 4 and 6. The syringe 3, as known in the art, may have a needle (not shown for sake of clarity) at the distal end (i.e., injecting end) which can be selected of an appropriate gauge and length for the application.

Although shown in FIGS. 7A-7G as a single liquid to be mixed 5 and a single solid to be mixed 7, it should be noted that this is a non-limiting example embodiment and it can be appreciated that additional powders, liquids, and/or other compounds and materials may be added as required to reconstitute particular solutions without departing from embodiments disclosed herein.

In some embodiments, sample containers 4 and 6 may be provided with cap element 70. The cap element 70 may be a removable or an irremovable aspect of a sample container. The cap element 70 may be, for example, a press-in stopper, a luer fitting, a snap fit, a threaded connection, or similar suitable closure element. In some embodiments, the cap element 70 may be configured to transition between an opened state and a closed state to permit or seal off the sample containers 4 and 6 prior to, during, or following a mixing procedure. The cap element 70 may have a passageway to receive a transfer device, such as a syringe. The passageway can be, for example, a pierceable membrane to be pierced by cannula or another central opening therethrough. The central opening may permit contents of the sample container to pass selectively therethrough (I.e., in one direction, in two directions, through a filter, etc.). The cap element 70 may be press-fit into the opening of the sample container, threaded over the opening, crimped onto the opening, or otherwise attached to the sample container.

The cap elements 70 may provide support for the cannula of an inserted syringe 3 and a seal for sterility and preventing air from being introduced into either the sample container or syringe. The introduction of ambient air may, for example, impede flow and/or cause flow cavitation in the syringe. In other embodiments, the mating ends of the syringe 3 and sample containers 4 and 6 may be fitted with a luer fitting, a grommet, a snap fit, threads, or other suitable attachment means. In some examples, the sample containers 4 and 6 may also have cap members or other closure elements which may be removed to access the contents therein.

In FIG. 7B, to introduce the liquid to be mixed 5 from sample container 4, the syringe 3 may be positioned and centered over the axis 9 of the sealed end of the sample container 4 with the cap element 70 so that the needle of the syringe 3 pierces the cap element 70 and sample container 4 and establishes a complete fluid pathway between the sample container 4 and the syringe 3. In some examples, the sample container 4 and syringe 3 combination may be at least partially inverted such that the sample container 4 is situated above the syringe 3. Inversion may aid in preventing air from being introduced while drawing the liquid to be mixed 5 into the syringe 3, as seen in FIG. 7C. Cap element 70 may provide support for the syringe 3 at the neck of the sample container 4 while the prescribed amount of the liquid to be mixed is extracted from the sample container 4. The syringe 3 containing the prescribed amount of the liquid to be mixed 5 may then be withdrawn from the sample container 4.

FIG. 7D shows the syringe 3 carrying the liquid to be mixed 5 centered with and pierced through the cap element 70 and sample container 6 containing the prescribed unit dosage of a solid to be mixed 7. In FIG. 7E, the prescribed amount of the liquid to be mixed 5 can be discharged from the syringe 3 and deposited into the sample container 6 containing the prescribed dosage of a solid to be mixed 7. The syringe 3 may be kept engaged and inserted into sample container 6 to preserve sterility of the distal end.

The combination of the syringe 3 and sample container 6 incorporating the unit dosages of the liquid to be mixed 5 and solid to be mixed 7 may then be inserted into a receptacle 63 of a mixing apparatus 50, such as those described in the embodiments herein. FIG. 7F illustrates how an open top of the mixing apparatus 50 allows the combination of the syringe 3 and sample container 6 to be accommodated therein without obstruction. The mixing device 50 may allow limited radial displacement of the syringe 3 and sample container 6 during the mixing operation but constrain the combination sufficiently so they do not tip and are maintain in the upright orientation.

The mixing device 50 may have, for example, a base 52 including a motor 57 capable of effective relative displacement of the sample container 6 in two or more directions for mixing and reconstituting the contents into a solution. An input device 54 may be used to change some operating points of the motor 57 so that, for example, the speed and/or vigor of the mixing operation can be tailored to obtain suspension of a homogenous solution 8. The motor 57 may be capable of inducing, for example, a radial displacement and an axial displacement of the sample container 6 relative to an axis 53 of the base 52. Applicant has recognized that motion of the sample container 6 in multiple, differing directions as being important to the consistency and fidelity of the mixing operation.

Although shown in FIG. 7F as a single sample syringe 3, sample container 6, and solution 8 in the mixing apparatus 50, it can be appreciated that additional materials to be mixed and reconstituted may be prepared, for example, as outlined in FIGS. 7A-E and described herein may be inserted into other available sample receptacles 63 for simultaneous reconstitution with the mixing apparatus 50 without departing from embodiments disclosed herein. The capability to reconstitute multiple sample containers simultaneously may allow the example mixing apparatus 50 to scale efficiency beyond, for example, manual mixing procedures. This efficiency may be useful, for example, when a serial workflow of dosages need to be prepared, or when multiple medications need to be reconstituted and delivered within a short time window.

Referring to FIG. 7G, the syringe 3 and sample container 6 containing the solution 8 may be removed together from the mixing apparatus 50. The reconstituted solution 8 may be aspirated into the syringe 3 for subsequent use.

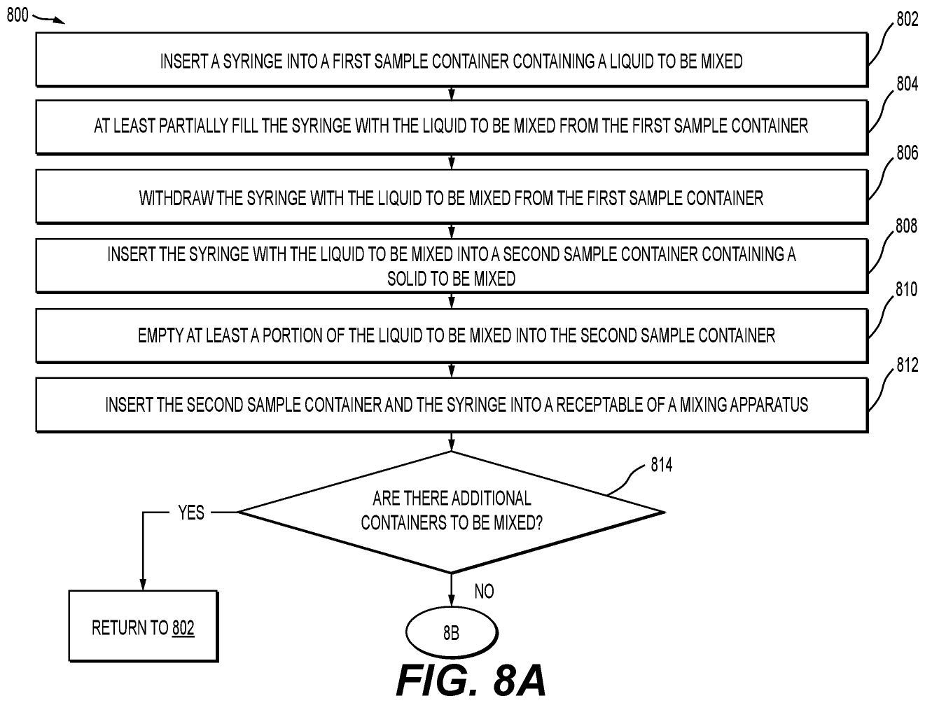

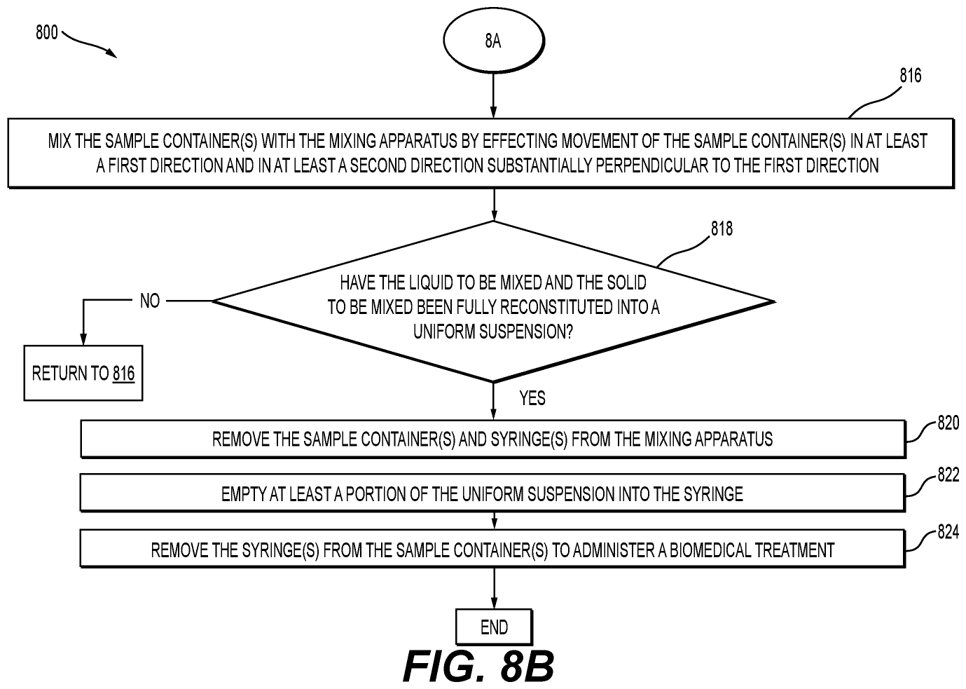

FIG. 8A and FIG. 8B are a block diagram of an example method 800 for mixing and reconstituting solutions utilizing, for example, any one or more of the example mixing apparatuses described herein, as well as others. The example method 800 is illustrated as a collection of blocks in a logical flow graph, which represent a sequence of operations. In some embodiments of the method 800, one or more of the blocks may be manually and/or automatically executed. The order in which the operations are described is not intended to be construed as a limitation, and any number of the described blocks may be combined in any order and/or in parallel to implement the method.

In FIG. 8A, at 802, the example method 800 may include inserting a syringe into a first sample container containing a liquid to be mixed. The liquid may be, for example, prescribed for reconstituting a particular solid, such as a powder. The diluent may be sterile or non-sterile and may include any of a number of other diluents and/or solvents such as those described herein. In some embodiments, the first sample container may have a cap element or similar fixture designed for the insertion and support of a syringe in the sample container.

At 804, the example method 800 may include at least partially filling the syringe with the liquid to be mixed from the first sample container. In some examples, the dosage quantity of the liquid to be mixed may already have been measured. In some examples, the quantity of the liquid to me mixed may need to be measured during aspiration into the syringe. At 806, the example method may involve withdrawing the syringe containing the liquid to be mixed from the first sample container.

A second sample container may contain a solid to be mixed, such as a pharmaceutical for reconstitution in powder form. In some examples, prior to adding the liquid diluent, the solid contents of the second sample container may be gently shaken to loosen and distribute the powder in the second sample container. The example method 800 may then include at 808 inserting the syringe with the liquid to be mixed into the second sample container, and at 810 emptying at least a portion of the liquid to be mixed into the second sample container.

The liquid to be mixed and the solid to be mixed are described for example purposes only and are not intended to be limiting. It can be readily appreciated that the constituents to be mixed may be solid-solid, solid-liquid, liquid-liquid, and other conditions as relevant to the application, and that one or more additional constituents in any of these and/or other forms may also be incorporated. The embodiments disclosed herein may also allow a user to better control parameters such as particle size and gelling during mixing.

An automated mixing apparatus may be used to reconstitute the contents of one or more sample containers safely and efficiently. An example mixing apparatus, such as those described herein, may have a base with a chassis containing a motor capable of effecting motion and displacement on the one or more sample containers in two or more different directions relative to the base. In some embodiments, the motor may be, for example, a stepper motor capable of delivering pulses in multiple directions through a shaft.

In some examples, the syringe may be kept at least partially inserted into the second sample container to protect the needle of the syringe and the contents of the container from potential contamination from exposure to the ambient environment. The example method 800 at 812 may include inserting the second sample container and the attached syringe into one of a plurality of receptacles of the example mixing apparatus. The receptacles may have, for example, a hollow cylindrical orientation or other configuration as described herein.

At 814, the example method 800 may involve determining if there are additional sample containers with contents to be reconstituted. The additional sample containers may include, for example, further dosages such as those prepared in the second sample container, or the additional sample containers may include other medications which need to be reconstituted and delivered within a short time. If it is determined, there are additional sample containers with contents requiring reconstitution, the example method 800 may involve returning to 802 to prepare the additional sample containers.

If it is determined, for example, that there are no additional samples containers to be prepared, or if all additional sample containers have been prepared for mixing, example method 800 at 816 (see FIG. 8B) may include mixing the second sample container and any additional sample containers for reconstitution determined at 814. In some embodiments, at least some of the sample containers and receptacles may be arranged, for example, so that an axis of at least one of the sample containers is offset eccentrically from an axis of the motor. The sample containers and receptacles may, for example, be radially constrained such that they remain upright during the mixing operation, as described herein. Empty receptacles may be inserted to constrain adjacent receptacles and/or to space a sample container away from the axis of the motor. Additionally, the syringes in each of the sample containers may be supported at the neck of the containers by the cap element during the mixing operation.

The motor of the example mixing apparatus can displace the sample containers and their contents in two or more directions relative to the base, and at least two of the different directions can be perpendicular, for example, as described herein (e.g., a radial displacement and axial displacement). The frequency and magnitude of the displacements effected by the motor during the mixing operation may be adjusted so as to achieve more complete mixing.

At 818, the example method 800 may include determining if the liquid to be mixed and the solid to be mixed in the second sample container and any additional sample containers have been fully reconstituted into a uniform suspension. The time for complete mixing may vary between solutions based on, for example, particle size of the powder, poor solubility leading to precipitation, and other factors as discussed herein. Where additional mixing is required, the example method can return to 816 and the example mixing apparatus may be, for example, run for an additional time interval and/or at different frequency and magnitude of the displacement operational points.

When it is determined that full reconstitution has occurred, the second sample container and any additional sample containers may, at 820 of the example method 800, be removed from the example mixing apparatus. At 822, the method may include emptying at least a portion of the solution from at least the second sample container into the attached syringe. At 824, the syringe can be removed from the second sample container and used, for example, to administer a biomedical treatment.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A mixing apparatus comprising:
a base comprising a motor and a shaft driven by said motor;
a head unit connected to said base having an internal volume and an opening for the shaft of the motor to extend therethrough; and
a plate in the internal volume of the head unit and connected to the shaft, the plate supporting at least one receptacle for housing at least one sample container therein;
wherein the motor is configured to mix contents of the at least one sample container by effecting displacement of the at least one sample container in a first direction relative to the base and a second direction relative to the base different from the first direction.

2. The mixing apparatus of claim 1, the at least one sample container being inserted from above into the at least one receptacle.

3. The mixing apparatus of claim 1, the at least one sample container comprising a syringe releasably attached thereto, the at least one sample container and syringe moved together by the motor relative to the base.

4. The mixing apparatus of claim 1, the second direction being substantially perpendicular to the first direction.

5. The mixing apparatus of claim 1, wherein the frequency of the motor is adjustable.

6. The mixing apparatus of claim 1, wherein the magnitude of the displacement effected by the motor is adjustable.

7. The mixing apparatus of claim 1, wherein the at least one receptacle is loosely arranged on the plate within the internal volume of the head unit.

8. The mixing apparatus of claim 1, wherein an axis of at least one receptacle is concentric with an axis of the motor.

9. The mixing apparatus of claim 1, wherein an axis of at least one receptacle is offset from an axis of the motor.

10. A mixing apparatus comprising:
a base comprising a motor and a shaft driven by said motor;
a base plate coupled to and driven by the shaft of the motor;
a head unit connected to said base plate, the head unit comprising a plurality of openings therein for receiving one or more receptacles;
wherein the one or more receptacles comprise a hollow interior for receiving one or more sample containers therein;
wherein the motor is configured to mix contents of the one or more sample containers by effecting displacement of the one or more sample containers in a first direction relative to the base and displacement in a second direction relative to the base different from the first direction; and
wherein the head unit constrains the radial motion of the one or more sample containers so the one or more sample containers are maintained in an upright orientation.

11. The mixing apparatus of claim 10, wherein at least one of the one or more sample container comprises a syringe releasably attached thereto, the sample container and syringe moved together by the head unit relative to the base.

12. The mixing apparatus of claim 10, the second direction being substantially perpendicular to the first direction.

13. The mixing apparatus of claim 10, wherein the frequency of the motor is adjustable.

14. The mixing apparatus of claim 10, wherein the amplitude of the displacement effected by the motor is adjustable.

15. The mixing apparatus of claim 10, wherein an axis of at least one of the one or more receptacles is offset from an axis of the motor.

16. The mixing apparatus of claim 10, wherein the one or more sample containers fit loosely within the hollow interior of the one or more receptacles.

17. A method for reconstituting a powder into a suspension, the method comprising:
inserting at least a first syringe into at least a first sample container containing a liquid to be mixed;
filling at least the first syringe with at least a portion of the liquid to be mixed;
withdrawing at least the first syringe containing the portion of the liquid to be mixed from at least the first sample container;
inserting at least a portion of at least the first syringe containing the portion of the liquid to be mixed into at least a second sample container containing a solid to be mixed;
emptying at least a portion of the liquid to be mixed from at least the first syringe into at least the second sample container;
inserting at least the second sample container with the portion of at least the first syringe therein into one of a plurality of receptacles in a mixing apparatus, the mixing apparatus comprising a base and a motor capable of effecting motion of at least the second sample container in two or more different directions relative to the base;
mixing the liquid to be mixed and the solid to be mixed by effecting said motion of at least the second sample container to form a uniform suspension of the liquid to be mixed and the solid to be mixed;
removing at least the second sample container with the portion of the syringe therein from the mixing apparatus;
emptying at least a portion of the uniform suspension from at least the second sample container into at least the first syringe; and
removing the portion of at least the first syringe from at least the second sample container.

18. The method of claim 17, further comprising:
shaking at least the second sample container containing the solid to be mixed prior to mixing with the liquid to loosen the solid to be mixed.

19. The method of claim 17, further comprising:
adjusting the frequency and magnitude of the displacement effected by the motor during the mixing.

20. The method of claim 17, wherein at least two of the two or more different directions of the displacement relative to the base are perpendicular.
